(19) United States
(12) Patent Application Publication
(10) Pub. No.: US 2009/0007184 A1
(43) Pub. Date: Jan. 1, 2009

(54) Recording apparatus, recording-apparatus control method, program and computer-readable recording medium

(75) Inventors: Yumiko Nakamura, Kawasaki (JP); Yoshifusa Togawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/230,697

(22) Filed: Sep. 3, 2008

Related U.S. Application Data
(63) Continuation of application No. PCT/JP2006/304723, filed on Mar. 10, 2006.

(51) Int. Cl. G06F 13/00

(52) U.S. Cl. 725/58

(57) ABSTRACT

A disclosed recording apparatus sets, when each scheduled recording of content is arranged, an attribute of the content, and resolves, in the case when a previously-arranged scheduled recording and a subsequently-arranged scheduled recording conflict with each other, the conflict according to priorities assigned to the attributes of the content pertaining to the previously-arranged and the subsequently-arranged scheduled recordings.

### CROSS-REFERENCE TO RELATED APPLICATION

This application is a U.S. continuation application filed under 35 USC 111(a) claiming benefit under 35 USC 120 and 365(c) of PCT application JP2006/304723, filed on Mar. 10, 2006. The entire contents of the foregoing application are hereby incorporated herein by reference.

### BACKGROUND OF THE INVENTION

1. Field of the Invention

The disclosures herein relate to a recording apparatus, a control method of the recording apparatus (hereinafter referred to as “recording-apparatus control method”), a program and a computer-readable recording medium. More particularly, the disclosures herein relate to a recording apparatus having a function of arranging a scheduled recording of information, a recording-apparatus control method, a program causing a computer to execute the recording-apparatus control method, and a computer-readable recording medium having the program stored thereon.

2. Description of the Related Art

Apparatuses having functions of receiving and recording television programs are known as an example of recording apparatuses for recording information. Some of such recording apparatuses have a function of allowing the user to make a scheduled recording of a predetermined program.

When a single recording apparatus is shared by two or more users, as in the case of home recording apparatuses, multiple users may desire to have scheduled recordings of television programs broadcast at the same time from multiple TV stations. Such a situation in which scheduled recordings conflict with each other is hereinafter referred to simply as “scheduled recording conflict”.

Patent Documents 1 and 2 disclose techniques for dealing with scheduled recording conflicts.

Patent Document 1 discloses a technology of, when there is a conflict in the time of scheduled recordings, facilitating the users involved to fix the conflict by transmitting a notice of the conflict together with relevant user information to one of the users who made a scheduled recording first.

Patent Document 2 discloses a technology of, when different scheduled recordings set by multiple users temporally overlap, automatically accommodating the conflict by selecting one scheduled recording according to a predetermined order of priority.

According to the structure of Patent Document 1, however, the actual resolution of the conflict has to be dealt with by the users and thus could be burdensome. Furthermore, the actual resolution may not be possibly carried out due to, for example, absence of either one of the users involved.

According to the structure of Patent Document 2, since the resolution of the conflict is automatically performed according to a predetermined order of priority, it may create a sense of unfairness among the users.

Patent Document 1: Japanese Laid-open Patent Application Publication No. 2003-309792

Patent Document 2: Japanese Laid-open Patent Application Publication No. 2005-101751

Patent Document 3: Japanese Laid-open Patent Application Publication No. 2001-36861

Patent Document 4: Japanese Laid-open Patent Application Publication No. 2004-235771

Patent Document 5: Japanese Laid-open Patent Application Publication No. H9-182035

Patent Document 6: Japanese Laid-open Patent Application Publication No. 2002-157821

Patent Document 7: Japanese Laid-open Patent Application Publication No. 2001-298686

Patent Document 8: Japanese Laid-open Patent Application Publication No. 2003-162884

Non-patent Document 1: URL:http://www.FMWORLD.net/biz/fmv/product/hard/security/f msec101/authenticate.html, “FMWORLD”, “KOUDO NA SHIMON NINSHO GIJYUTU (Advanced Fingerprint Authentication Technology)” (Jan. 26, 2006)

### SUMMARY OF THE INVENTION

There is a need to provide a recording apparatus capable of, even if a scheduled recording conflict occurs among users sharing a single recording apparatus, automatically resolving the conflict without generating a sense of unfairness over the resolution result; a recording-apparatus control method; a program causing a computer to execute the recording-apparatus control method; and a computer-readable recording medium having the program stored thereon.

One embodiment of the recording apparatus may include an attribute setting unit configured to set, when each scheduled recording of content is arranged, an attribute of the content; and a conflict resolving unit configured to, in the case when a previously-arranged scheduled recording and a subsequently-arranged scheduled recording conflict with each other, resolve the conflict according to priorities assigned to the attributes of the content pertaining to the previously-arranged and the subsequently-arranged scheduled recordings.

### BRIEF DESCRIPTION OF THE DRAWINGS

FIG. 1 shows an appearance of a personal computer which is applicable as a recording apparatus of one embodiment of the present disclosures;

FIG. 2 is a block diagram showing an internal structure of the personal computer of FIG. 1;

FIG. 3 is a functional block diagram of the recording apparatus of one embodiment of the present disclosures;

FIG. 4A is a flowchart (Part 1) illustrating operations for user registration performed in the recording apparatus of one embodiment of the present disclosures;

FIG. 4B shows an example of a registrant list screen for displaying a list of users registered in the user registration of FIG. 4A;

FIG. 4C is a flowchart (Part 2) illustrating operations for user registration performed in the recording apparatus of one embodiment of the present disclosures;

FIG. 5 is a flowchart (Part 1) illustrating operations performed on the recording apparatus of one embodiment of the present disclosures at the time of a scheduled recording request;

FIG. 6 shows an example of a content attribute setting screen presented to the user during the operations of FIG. 5;

FIG. 7 is a flowchart (Part 2) illustrating operations performed on the recording apparatus of one embodiment of the present disclosures at the time of the scheduled recording request; and

FIG. 8 shows an example of a scheduled-recording management record in the recording apparatus of one embodiment of the present disclosures.

### DETAILED DESCRIPTION OF THE PREFERRED EMBODIMENT

The following describes a recording apparatus and a recording-apparatus control method according to one embodiment of the present disclosures with reference to the drawings.

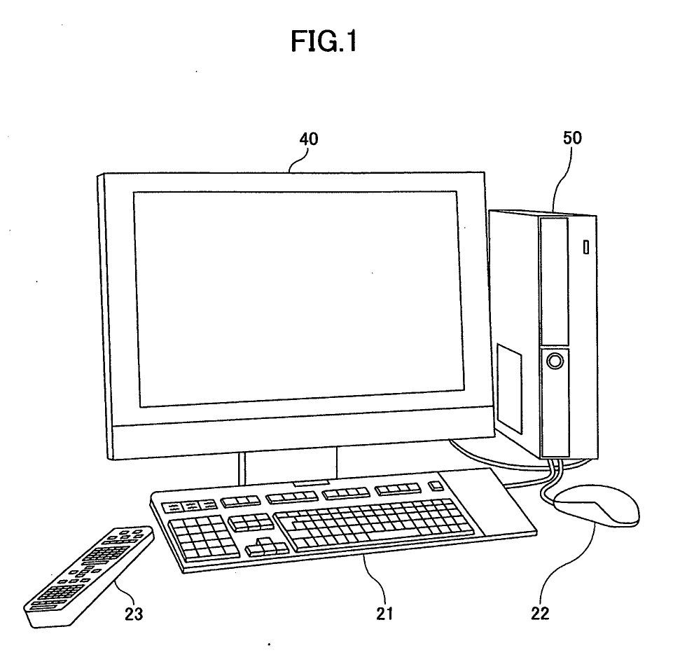

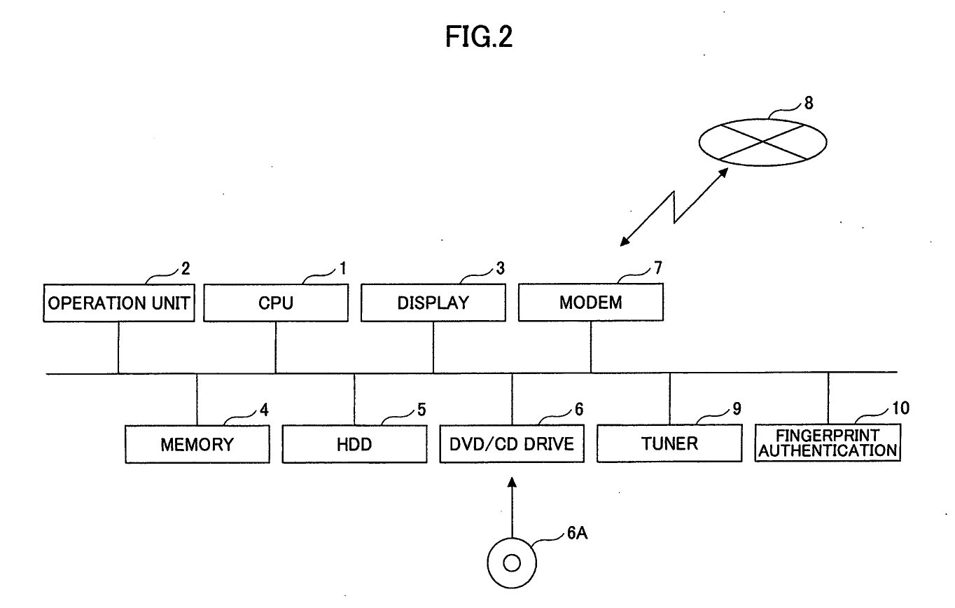

FIG. 1 shows an appearance of a personal computer which is applicable as a recording apparatus of one embodiment of the present disclosures. FIG. 2 is a block diagram showing an internal structure of the personal computer.

As shown in FIG. 1, the personal computer includes a main body 50, a display 40, a keyboard 21, a mouse 22 and a remote controller 23.

As shown in FIG. 2, the main body 50 of the personal computer includes a CPU 1, a memory 4, a hard disk drive 5, a DVD/CD drive 6, a modem 7 and a tuner 9.

In addition, the personal computer is equipped with a display 3 corresponding to the display 40; an operation unit 2 corresponding to the keyboard 21, mouse 22 and remote controller 23; and a fingerprint authentication device 10 (not shown in FIG. 1).

These components are connected by a bus so as to communicate with each other. The tuner 9 and the fingerprint authentication device 10 are connected to the bus via necessary interfaces (not shown).

The fingerprint authentication device 10 is configured to detect fingerprint information when the user slides his/her finger over a sensor.

By including the tuner 9, the personal computer allows reception and viewing of television programs. Also, the personal computer is configured so that information of the received television programs (hereinafter referred to simply as “content”) is stored in the hard disk drive 5 or a DVD 6A via the DVD/CD drive 6 (hereinafter “hard disk drive 5 or the like”) and can be later played back for viewing.

To receive and view the content on the personal computer, the tuner 9 is connected to a designated receiving antenna and then brought in operation. Using similar operations as for a general TV receiver, the user is able to view received content or playback content on the display 40 (3) of the personal computer using the remote controller 23.

The fingerprint authentication device 10 is used as a user identification/authentication device of the personal computer, as described below.

Structural components of the personal computer configured for functions other than content reception, content recording, content playback and content viewing are the same as those of a publicly-known personal computer, and therefore their detailed descriptions are omitted herein.

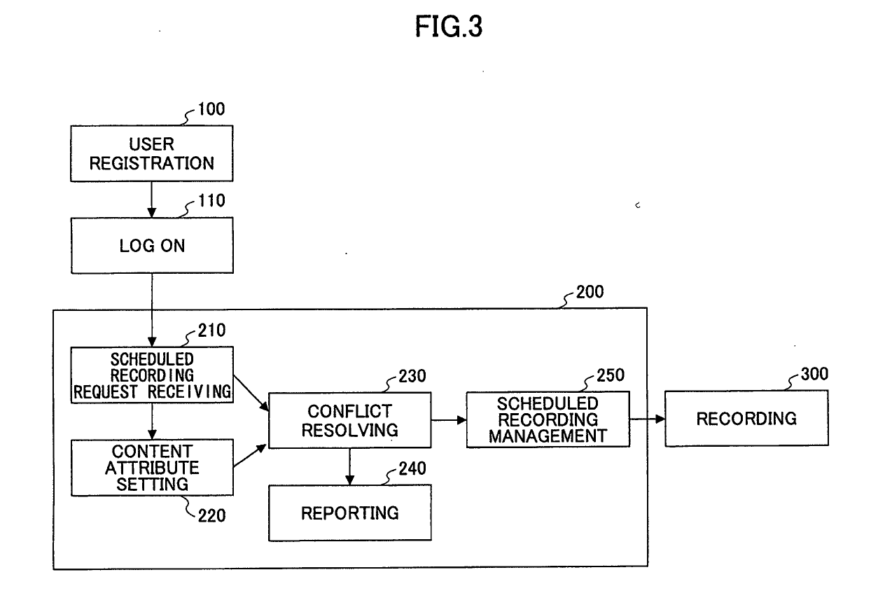

Next is described a recording-apparatus control method according to one embodiment of the present disclosures with reference to FIGS. 3, 4A through 4C, 6, 7 and 8.

The recording-apparatus control method described herein is implemented as functions of the personal computer mentioned above with reference to FIGS. 1 and 2. In the present embodiment, the personal computer is applied as a recording apparatus.

That is to say, the recording-apparatus control method according to an embodiment of the present disclosures is provided by creating a control program including instructions causing the CPU 1 of the personal computer to execute the control method. The control program is stored, for example, in the CD-ROM 6A, which is a portable recording medium. The program is then loaded in the hard disk drive 5 of the personal computer via the DVD/CD drive 6. The CPU 1 loads the program from the hard disk drive 5 into the memory 4, and executes the recording-apparatus control method by sequentially reading and executing the instructions.

Note that a means for loading the control program into the personal computer is not limited to the use of a portable recording medium. For example, it may be achieved by downloading the program from an external server via a communication network 8, such as the Internet, using the modem 7.

More specifically, the CPU 1 uses the display 3, memory 4, hard disk drive 5, DVD/CD drive 6, tuner 9, fingerprint authentication device 10 and the like according to the instructions of the program, whereby the recording-apparatus control method is executed.

As shown in FIG. 3, the recording-apparatus control method, which is provided as functions of the control program when the CPU 1 executes the control program, is implemented by functional components including a user registration unit 100, a log on unit 110, a scheduling unit 200 and a recording unit 300.

The scheduling unit 200 is composed of a scheduled recording request receiving unit 210, a content attribute setting unit 220, a conflict resolving unit 230, a reporting unit 240 and a scheduled recording management unit 250.

Functions of these functional components are as follows.

The user registration unit 100 is a functional component for registering a user with a personal computer serving as the recording apparatus of one embodiment of the present disclosures. A user registered by the user registration unit 100 is hereinafter referred to simply as “registered user”. A registered user registers an email address (hereinafter “mail address”) of his/her portable information terminal (e.g. a mobile phone), as described later.

The log on unit 110 is a functional component for allowing a registered user to log on to a personal computer serving as the recording apparatus of one embodiment of the present disclosures.

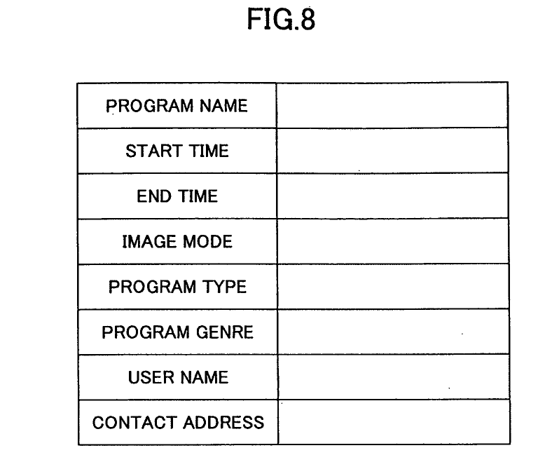

The scheduling unit 200 is a functional component for receiving a request for a scheduled recording of content (hereinafter “scheduled recording request”) from a user who has logged on to the personal computer (hereinafter “logged-on user”) by the log on unit 110 and recording and managing the requested scheduled recording in the form of a scheduled-recording management record as shown in FIG. 8.

In the present embodiment, the above-mentioned mail address of a registered user pertaining to the requested scheduled recording, in addition to the name of the user, is recorded in the scheduled-recording management record as a “contact address” of the user, as shown in FIG. 8. The contact address of the user is registered in the user registration described above.

The recording unit 300 is a functional component for executing recording of predetermined content (i.e. video recording) according to instructions from the scheduling unit 200. The content recording is achieved when the recording unit 300 stores content received by the tuner 9 in the hard disk drive 5 or the like.

In the scheduling unit 200, the scheduled recording request receiving unit 210 is a functional component for receiving a scheduled recording request in response to a scheduled recording request-related operation performed by a logged-on user on the keyboard 21, the mouse 22 or the like, which serves as the operation unit 2. The content attribute setting unit 220 is a functional component for, at the time of receiving a scheduled recording request, setting content attributes pertaining to the scheduled recording request.

The conflict resolving unit 230 compares the broadcast start time and end time of a television program (i.e. content) pertaining to a newly-requested, or subsequently-requested, scheduled recording against the broadcast start time and end time pertaining to a previously-requested scheduled recording. The broadcast start time and end time of the previously-requested scheduled recording are shown in the scheduled-recording management record of FIG. 8 managed by the scheduled recording management unit 250. As a result, if an overlap is found in these periods of time, the conflict resolving unit 230 regards it as the occurrence of a scheduled recording conflict.

In this case, it is necessary to select either one of the requested scheduled recordings causing the scheduled recording conflict. Accordingly, the conflict resolving unit 230 compares, with respect to these conflicting scheduled recordings, content attributes set by the content attribute setting unit 220. Based on the comparison result, the conflict resolving unit 230 determines the order of priority between the conflicting scheduled recordings, thereby selecting one of them. The selection result is issued to the reporting unit 240 and the scheduled recording management unit 250.

Receiving the selection result, the scheduled recording management unit 250 ignores the subsequently-requested scheduled recording in the case where the previously-requested scheduled recording is selected, and keeps the scheduled-recording management record of the previously-requested scheduled recording. On the other hand, in the case where the subsequently-requested scheduled recording is selected, the scheduled recording management unit 250 deletes the scheduled-recording management record of the previously-requested scheduled recording, and then generates and manages a scheduled-recording management record pertaining to the subsequently-requested scheduled recording—that is, a scheduled-recording management record pertaining to a scheduled recording requested by a currently logged-on user.

Receiving the selection result from the conflict resolving unit 230, the reporting unit 240 displays on the display 3 a notice indicating a failure in securing the scheduled recording requested by the logged-on user in the case where the previously-requested scheduled recording is selected. On the other hand, in the case where the subsequently-requested scheduled recording is selected, the reporting unit 240 transmits a message indicating cancellation of the previously-requested scheduled recording to a mail address shown in the “contact address” of the scheduled-recording management record pertaining to the previously-requested scheduled recording. In order to inform the reason for the cancellation, the message to be transmitted includes, for example, the user name of the subsequently-requested scheduled recording, as well as information for identifying the content (such as the name of the television program) of the subsequently-requested scheduled recording to justify the priority determination.

Herewith, the user of the previously-requested scheduled recording is able to learn the reason for the cancellation of his/her requested scheduled recording together with the justification for the priority determination, and accordingly is likely to reach a certain level of acceptance of the cancellation. That is to say, by learning the user name of the other user in the scheduled recording conflict and the name of the content requested by the other user, the user whose requested scheduled recording has been cancelled is able to recognize, for instance, a strong desire/demand of the other user to record his/her requested content, and, as a result, to reach a certain level of acceptance of the result of the conflict resolution.

The scheduled recording management unit 250 compares the “start time” of each of self-managing scheduled-recording management records (FIG. 8) with the current time, and automatically starts the tuner 9 to receive corresponding content when such a “start time” comes. The content received by the tuner 9 is stored by the recording unit 300 into the hard disk drive 5 or the like. After recording of the corresponding content is completed, the scheduled recording management unit 250 deletes a corresponding scheduled-recording management record.

The following gives further details of the recording-apparatus control method according to one embodiment of the present disclosures.

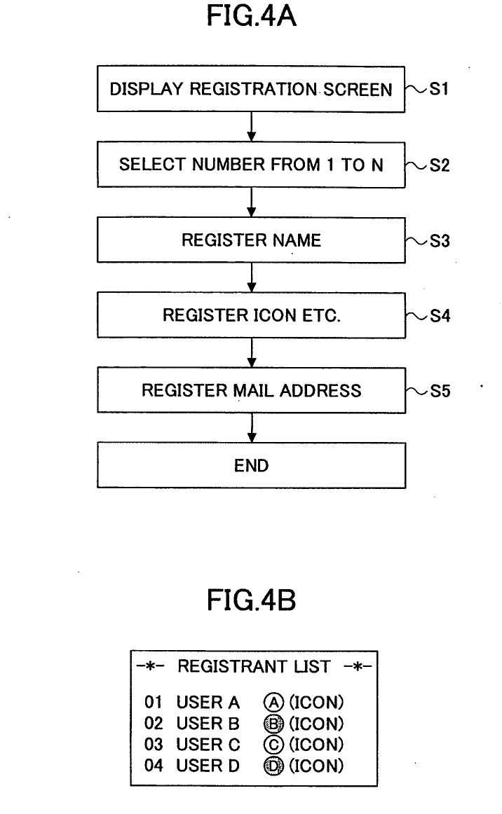

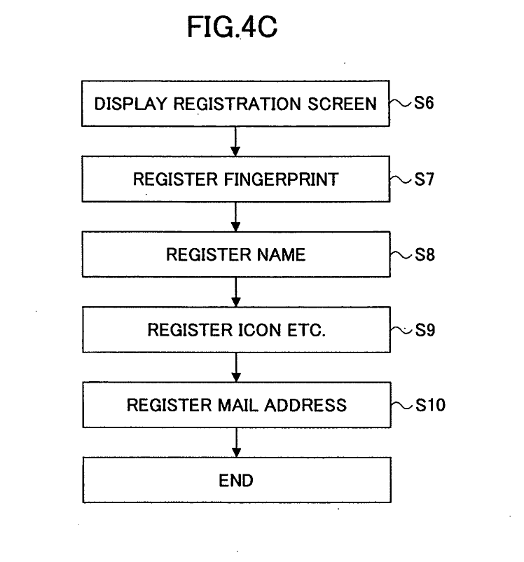

FIGS. 4A through 4C are flowcharts illustrating operational flows of the user registration performed by the user registration unit 100.

FIG. 4A shows an example in which the user registration is performed using a number, and FIG. 4C shows an example in which the user registration is performed using fingerprint information.

In FIG. 4A, in Step S1, the user registration unit 100, which is one function of the control program executed by the CPU 1, displays a predetermined registration screen on the display 3. According to guidance on the screen, the user selects a number from the numbers 1 to N as his/her number (Step S2). Then, the user registers his/her name (Step S3) and selects an identification mark, such as an icon, which provides an easy visual representation (Step S4). Additionally, the user registers his/her mail address (Step S5), as described above. Consequently, the user is registered as a user of a personal computer, which serves as the recording apparatus of one embodiment of the present disclosures.

From a security standpoint, instead of the “registration number”, a “password” may be registered together with the “user name” in the user registration. In this case, the user needs to input the “user name” and “password” at the time of logon (to be described below). That is, user authentication is performed.

FIG. 4B shows an example of a screen displaying a list of users registered in this manner. As shown in the screen, according to the operations of the user registration described above with reference to FIG. 4A, registration numbers 01 through 04 are registered together with icons A through D for users A through D, respectively.

Similarly, in FIG. 4C, when a predetermined registration screen is displayed on the display 3 in Step S6, a user registers his/her fingerprint information via the fingerprint authentication device 10 according to guidance on the screen (Step S7). Then, the user registers his/her name (Step S8), and selects an identification mark, such as an icon (Step S9). Subsequently, the user registers his/her mail address (Step S10). As a result, the user is registered as a user of a personal computer, which serves as the recording apparatus of one embodiment of the present disclosures.

Next is described the registration of the fingerprint information of Step S7. In the present embodiment, a unique fingerprint authentication technology developed by the applicants of the present disclosures is applied to a fingerprint information acquisition process using the fingerprint authentication device 10 and to a fingerprint cross-checking process performed at the time when a scheduled recording request is made using user's fingerprint information acquired and registered in the former process.

The fingerprint authentication technology adopts a unique “Connected Minutiae Relation Method” that cross-checks correlations between minutiae (ridge endings and ridge bifurcations)-such as orientations and positional relationships of the minutiae included in a fingerprint pattern. This technology achieves a correct acceptance rate of 99% or more and a false acceptance rate of 0.002% or less, thus delivering high-accuracy fingerprint recognition performance. Furthermore, the fingerprint cross-checking can be carried out with a relatively small amount of fingerprint data of an average of about 300 bytes per finger, whereby high-speed cross-checking is achievable. Also, according to the technology, the fingerprint data is irreversible and therefore cannot be restored to an actual fingerprint image, thereby providing reliable privacy protection (see Non-patent Document 1).

By the application of the fingerprint authentication technology, when a user slides his/her finger over a sensor of the fingerprint authentication device 10 to make a request for a scheduled recording of content, fingerprint information detected by the sensor is cross-checked with the user's fingerprint information having already been acquired and registered in the above-mentioned fingerprint information acquisition process. When the information matches each other, the user is allowed to log on by the log on unit 110, which is one function of the control program executed by the CPU 1, and the scheduled recording request receiving unit 210 starts a process of receiving a scheduled recording request from the logged-on user. Thus, in this case, the user registration unit 100 has a function of acquiring fingerprint information and the log on unit 110 has a function of cross-checking fingerprint information.

The application of the fingerprint authentication technology allows the user to use the scheduled recording request function to which the user authentication function is added, thus eliminating the necessity of keying-in the “user name”, “password” and the like at each time of the user registration and the user logon.

Note that a publicly-known fingerprint authentication technology may be applied to the present disclosures, and accordingly, detailed descriptions of the structure are omitted herein.

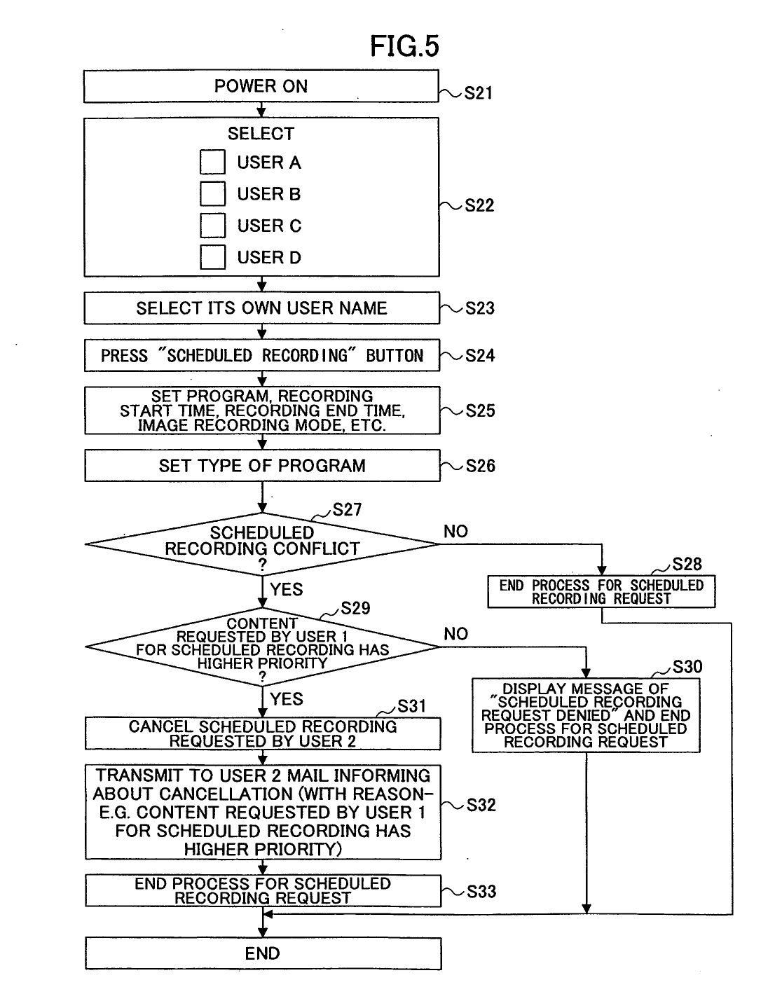

FIG. 5 is a flowchart illustrating an operational flow performed on the recording apparatus at the time when a registered user makes a request for a scheduled recording of content.

When a personal computer serving as the recording apparatus of one embodiment of the present disclosures is powered on (Step S21), a log-on screen like one shown in Step S22 is displayed on the display 3 by the log on unit 110. On this display, the user selects his/her own user name. Note that in the case where the user registration using fingerprint information (described above in reference to FIG. 4C) is applied, the user simply slides his/her finger over the sensor of the fingerprint authentication device 10 at the logon stage (Steps S22 and S23). As a result, the user is able to automatically log on by the above-mentioned fingerprint cross-checking function.

Next, the user clicks on a “scheduled recording” button displayed by the scheduled recording request receiving unit 210 on the display 3 (Step S24). As a result, a scheduled recording screen (that is, a screen for making a request for a scheduled recording of content) is displayed on the display 3 by the scheduled recording request receiving unit 210. On the screen, the user performs on the keyboard 21, the mouse 22 or the like serving as the operation unit 2 the operation of setting a program (content of which the user wants to record), broadcast start time and end time of the program, an image recording mode and the like (Step S25).

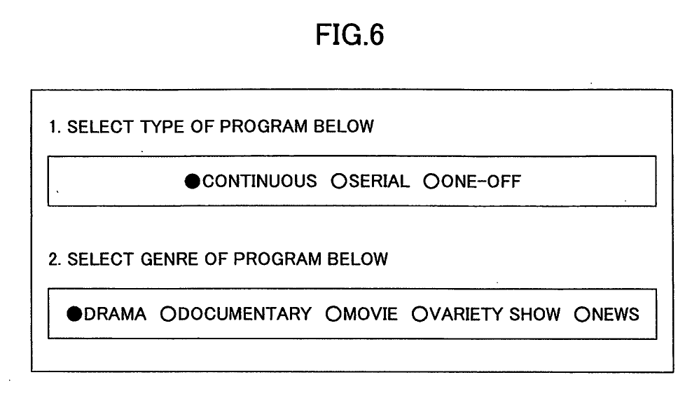

Then, a content attribute setting screen, like one shown in FIG. 6, is displayed on the display 3 by the content attribute setting unit 220, which is one function of the control program executed by the CPU 1 (Step S26). On the screen, the user makes selections on appropriate items. As a result, information is set in the items “program type” and “program genre” of the scheduled-recording management record (FIG. 8) pertaining to this scheduled recording request.

Specifically, the user selects one of “continuous”, “serial” and “one-off” on the screen shown in FIG. 6 regarding the type of the content pertaining to the scheduled recording request—i.e. the type of a television program that the user wants to record. Next, also regarding the genre of the television program, the user selects one of “drama”, “documentary”, “movie”, “variety show” and “news” on the screen of FIG. 6.

Assume here that the priority of the program types shown in FIG. 6—i.e. “continuous”, “serial” and “one-off”—decreases in the stated order. That is, the highest priority is assigned to “continuous” while the lowest priority is assigned to “one-off”.

In the same manner, the priority of the program genres shown in FIG. 6—i.e. “drama”, “documentary”, “movie”, “variety show” and “news”—decreases in the stated order. That is, the highest priority is assigned to “drama” while the lowest priority is assigned to “news”.

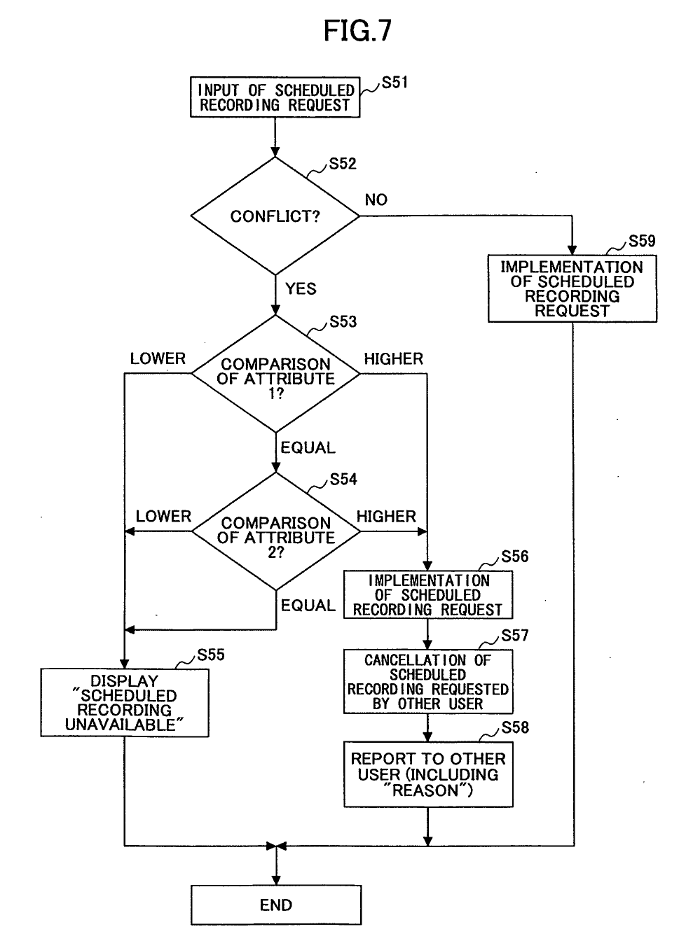

Note that the “priority” herein is referred to by the conflict resolving unit 230 of FIG. 3 to resolve the scheduled recording conflict. The details are described below with reference to FIG. 7.

Note that content attributes pertaining to a requested scheduled recording may not have to be set by users. For example, one embodiment of the present disclosures may be configured such that the content attribute setting unit 220 automatically obtains and sets attributes of corresponding content using a publicly-known EPG (electronic program guide) function.

Referring back to FIG. 5, after the user setting process for the scheduled recording request is completed by the operations up to Step S26, the conflict resolving unit 230 determines if there is a scheduled recording conflict, based on the information obtained by the user setting process with respect to the scheduled recording request (Step S27). Namely, the conflict resolving unit 230 compares the program broadcast start time and end time of the scheduled recording request, which are set by the user (hereinafter referred to as “User 1”) in Step S25, with the “start time” and “end time” of the scheduled-recording management record (FIG. 8) managed by the scheduled recording management unit 250 with respect to each previously-requested scheduled recording.

If it is determined that there is no overlap between the compared periods of the scheduled recordings (NO in Step S27), the result is issued from the conflict resolving unit 230 to the scheduled recording management unit 250. The scheduled recording management unit 250 generates a scheduled-recording management record (FIG. 8) for the subsequently-requested scheduled recording based on the information of the scheduled recording request made by User 1—i.e. the information set in Steps S25 and S26, and manages the generated scheduled-recording management record.

On the other hand, if it is determined that there is an overlap between the compared periods of the scheduled recordings (YES in Step S27), the conflict resolving unit 230 determines an occurrence of a scheduled recording conflict. Assume here that a scheduled recording has previously been requested by a user referred to as “User 2” (which is a different individual from User 1) and that the previously-requested scheduled recording conflicts with the scheduled recording subsequently requested by User 1.

In this case, the conflict resolving unit 230 performs a conflict resolving procedure to resolve the conflict between these scheduled recordings. Specifically, the conflict resolving unit 230 compares “program types” and “program genres” of the conflicting scheduled recordings requested by User 1 and User 2. Then, according to the above-mentioned priority orders, the conflict resolving unit 230 determines priority between the two scheduled recording requests.

If the content of the scheduled recording previously requested by User 2 is determined to have a higher priority (NO in Step S29), the conflict resolving unit 230 informs the reporting unit 240 accordingly. In response, the reporting unit 240 displays on the display 3 a message indicating that “the scheduled recording subsequently requested by User 1 is denied (unavailability of the subsequently-requested scheduled recording)” (Step S30). Herewith, User 1 becomes aware of the unavailability. In this case, the conflict resolving unit 230 does not send any notice to the scheduled recording management unit 250, and no change is made to the scheduled-recording management record managed by the scheduled recording management unit 250.

Note that, in the above case, the reporting unit 240 may also display on the display 3 the reason for the unavailability, indicating that a scheduled recording conflict occurred in relation to the scheduled recording requested by User 1 and that, as a result of the conflict resolving procedure, the scheduled recording previously requested by User 2 has been given higher priority according to the order of priority in the content attributes. Herewith, User 1 is likely to reach a certain level of acceptance of the unavailability of the scheduled recording he/she has requested.

On the other hand, if the content of the scheduled recording subsequently requested by User 1 is determined in Step S29 to have a higher priority (YES in Step S29), the conflict resolving unit 230 informs the scheduled recording management unit 250 accordingly. In response, the scheduled recording management unit 250 deletes the scheduled-recording management record of the scheduled recording previously requested by User 2 (Step S31).

The conflict resolving unit 230 informs the result determined in Step S29 also to the reporting unit 240. In response, the reporting unit 240 transmits a message to a mail address, which is the “contact address” of User 2, included in the scheduled-recording management record (FIG. 8) of the conflicting scheduled recording requested by User 2. The message includes a notice informing that the scheduled recording requested by User 2 has been cancelled as well as the reason for the cancellation, indicating that a scheduled recording conflict occurred in relation to the scheduled recording requested by User 2 and that, as a result of the conflict resolving procedure, the scheduled recording subsequently requested by User 1 has been given higher priority according to the order of priority in the content attributes.

The scheduled recording management unit 250 generates and then manages the scheduled-recording management record (FIG. 8) for the scheduled recording requested by User 1 (Step S33).

According to the above configuration, even if a scheduled recording request once accepted is cancelled as a result of the conflict resolving procedure performed to resolve a subsequently-occurring scheduled recording conflict, the user (User 2 in the above example) whose requested scheduled recording has been cancelled is informed about the reason for the cancellation as well as the grounds for the resolution determination. The determination is made objectively in the conflict resolving procedure based on the content attributes of the conflicting scheduled recordings. As a result, the user whose requested scheduled recording has been cancelled is likely to reach a certain level of acceptance of the cancellation.

Particularly, the user whose requested scheduled recording has been cancelled may be able to learn the circumstances of the other user involved in the scheduled recording conflict by obtaining information including the user name of the other user, the name of the content (i.e. program name) requested by the other user. Herewith, the user is likely to reach acceptance of the cancellation of its own requested scheduled recording. The notice sent to the user whose requested scheduled recording has been cancelled may simply include at least either the “user name” of the other user or the “name of content” of the scheduled recording requested by the other user. This is because a similar effect is believed to be achieved.

The following gives a detailed description of the determination of the content priority (Step S29) in the conflict resolving procedure performed by the conflict resolving unit 230 with reference to FIG. 7.

First, a user operation related to a scheduled recording request is performed on the operation unit 2 of a personal computer serving as the recording apparatus of one embodiment of the present disclosures (Step S51). In response, the conflict resolving unit 230 of the scheduling unit 200, which is one function of the control program executed by the CPU 1, compares the information of the currently-made scheduled recording request with the information of the scheduled-recording management record (FIG. 8) pertaining to the previously-requested scheduled recording, as described above. Herewith, the conflict resolving unit 230 determines whether there is a scheduled recording conflict (Step S52). In the case of no conflict, the conflict resolving unit 230 implements the currently-made scheduled recording request (Step S59).

On the other hand, in the case where there is a scheduled recording conflict (YES in Step S52), the conflict resolving unit 230 makes a comparison with respect to Attribute 1 (Step S53). The comparison with respect to Attribute 1 means a comparison regarding “Type of Program” shown in FIG. 6 (corresponding to “Program Type” of FIG. 8) among content attributes set for the conflicting scheduled recordings. In the present embodiment, “Type of Program” (Program Type) particularly indicates a broadcasting style of the program (i.e. a providing style of content).

For example, assume the case where “continuous” is set to the program type of the content pertaining to the previously-requested scheduled recording and “one-off” is set to the program type of the content pertaining to the subsequently-requested scheduled recording. As described above, since “continuous” has a higher priority, the content of the previously-requested scheduled recording is given higher priority. Accordingly, in this case, the previously-requested scheduled recording is selected and the subsequently-requested scheduled recording is rejected (“lower” in Step S52). Consequently, a message indicating the result is displayed on the display 3 (Step S55).

Contrarily, in the case where “one-off” is set to the program type of the content pertaining to the previously-requested scheduled recording and “continuous” is set to the program type of the content pertaining to the subsequently-requested scheduled recording, the content of the subsequently-requested scheduled recording is given higher priority since “continuous” has a higher priority, as described above. Accordingly, in this case, the subsequently-requested scheduled recording is selected and the previously-requested scheduled recording is cancelled (“higher” in Step S52, and Steps S56 and S57). Then, an email informing about the result is transmitted to the user of the previously-requested scheduled recording (Step S58).

Let us assume another case where “continuous” is set both to the program type of the content pertaining to the previously-requested scheduled recording and to the program type of the content pertaining to the subsequently-requested scheduled recording. Since the priority between the conflicting scheduled recordings is equal, the order of priority cannot be determined (“equal” in Step S53). In this case, a further comparison is made with respect to Attribute 2 (Step S54).

The comparison with respect to Attribute 2 means a comparison regarding “Genre of Program” shown in FIG. 6 (corresponding to “Genre Type” of FIG. 8) among content attributes set for the conflicting scheduled recordings. In the present embodiment, the “Genre of Program” (Program Genre) particularly indicates description of the program.

For example, assume the case where “drama” is set to the program genre of the content pertaining to the previously-requested scheduled recording and “news” is set to the program genre of the content pertaining to the subsequently-requested scheduled recording. As described above, since “drama” has a higher priority, the content of the previously-requested scheduled recording is given higher priority. Accordingly, in this case, the previously-requested scheduled recording is selected and the subsequently-requested scheduled recording is rejected (“lower” in Step S54). Consequently, a message indicating the result is displayed on the display 3 (Step S55).

Contrarily, in the case where “news” is set to the program genre of the content pertaining to the previously-requested scheduled recording and “drama” is set to the program genre of the content pertaining to the subsequently-requested scheduled recording, the content of the subsequently-requested scheduled recording is given higher priority since “drama” has a higher priority, as described above. Accordingly, in this case, the subsequently-requested scheduled recording is selected and the previously-requested scheduled recording is cancelled (“higher” in Step 54, and Steps S56 and S57). Then, an email informing about the result is transmitted to the user of the previously-requested scheduled recording (Step S58).

Let us assume another case where “drama” is set both to the program genre of the content pertaining to the previously-requested scheduled recording and to the program genre of the content pertaining to the subsequently-requested scheduled recording. Since the priority between the two recordings is equal, the order of priority cannot be determined (“equal” in Step S54). In this case, the previously-requested scheduled recording is given priority. Consequently, a message indicating the result is displayed on the display 3 (Step S55).

Thus, according to the present embodiment, the priority determination is carried out in two stages (Steps S53 and S54). Therefore, it is possible to make a final determination on the order of priority of requested scheduled recordings in a reliable manner even in the case of using two different categories of content attributes.

Note that specific categorical content attributes and the priority determination procedure are not limited to those described above with reference to FIGS. 6 and 7. Based on agreements of group members sharing a personal computer serving as the recording apparatus of one embodiment of the present disclosures, various categorical content attributes are conceivable, and similarly, various priority determination procedures are possible. Accordingly, the categorical content attributes and the priority determination procedure according to the categorical content attributes are preferably designed to be customizable.

The present embodiment relates to a personal computer serving as a recording apparatus; however, the recording apparatus of the present disclosures is not limited to this case. The present disclosures are also applicable to, for example, a dedicated hard disk and/or a DVD recording apparatus.

According to one embodiment of the present disclosures, it is possible to automatically resolve a scheduled recording conflict based on priorities assigned to attributes of the content pertaining to conflicting scheduled recordings. In addition, since determination criteria for resolving the conflict are made objectively, a user whose requested scheduled recording is cancelled or rejected is likely to reach a certain level of acceptance of the cancellation or rejection.

According to one embodiment of the present disclosures, when a conflict occurs between scheduled recordings, a determination is made based on attributes of content of these scheduled recordings in order to resolve the conflict. As a result, users are likely to reach acceptance of the result of the conflict resolution. Therefore, even when the conflict resolution is automatically carried out, it is possible to prevent creating a sense of unfairness between the users.

What is claimed is:

1. A recording apparatus having a function of arranging one or more scheduled recordings of content, comprising:
an attribute setting unit configured to set an attribute of content when each scheduled recording is arranged, a predetermined priority being assigned to each attribute; and
a conflict resolving unit configured to, in a case when a previously-arranged scheduled recording and a subsequently-arranged scheduled recording conflict with each other, resolve the conflict according to priorities assigned to attributes of content of the previously-arranged and the subsequently-arranged scheduled recordings.

2. The recording apparatus as claimed in claim 1, further comprising: an informing unit configured to inform, in a case of cancelling the previously-arranged scheduled recording and selecting the subsequently-arranged scheduled recording in accordance with the priorities so as to resolve the conflict, a user that requested the previously-arranged scheduled recording about the cancellation and information related to the cancellation.

3. The recording apparatus as claimed in claim 2, wherein the information related to the cancellation includes at least one of a user name and a content name pertaining to the subsequently-arranged scheduled recording.

4. The recording apparatus as claimed in claim 1, wherein the attribute of the content of each scheduled recording includes a first categorical attribute related to a providing style of the content and a second categorical attribute related to a characteristic of the content.

5. The recording apparatus as claimed in claim 4, wherein the conflict resolving unit includes:
a first comparing subunit configured to compare the previously-arranged and the subsequently-arranged scheduled recordings with respect to the first categorical attribute;
a second comparing subunit configured to compare the previously-arranged and the subsequently-arranged scheduled recordings with respect to the second categorical attribute; and
a determining subunit configured to determine selection of one of the previously-arranged and the subsequently-arranged scheduled recordings, the selection being determined according to a priority order between the previously-arranged and the subsequently-arranged scheduled recordings in a case where the priority order is obtained based on a result of the comparison by the first comparison subunit, and the selection being determined based on a result of the comparison by the second comparison subunit in a case where the priority order is not obtained based on the result of the comparison by the first comparison subunit.

6. A control method of a recording apparatus having a function of arranging one or more scheduled recordings of content, the control method comprising the steps of:
(a) setting an attribute of content when each scheduled recording is arranged; and
(b) in a case when a previously-arranged scheduled recording and a subsequently-arranged scheduled recording conflict with each other, resolving the conflict according to priorities assigned to attributes of content of the previously-arranged and the subsequently-arranged scheduled recordings.

7. The control method as claimed in claim 6, further comprising the step of:
(c) informing, in a case of cancelling the previously-arranged scheduled recording and selecting the subsequently-arranged scheduled recording in accordance with the priorities so as to resolve the conflict, a user that requested the previously-arranged scheduled recording about the cancellation and information related to the cancellation.

8. The control method as claimed in claim 7, wherein the information related to the cancellation includes at least one of a user name and a content name pertaining to the subsequently-arranged scheduled recording.

9. The control method as claimed in claim 6, wherein the attribute of the content of each scheduled recording includes a first categorical attribute related to a providing style of the content and a second categorical attribute related to a characteristic of the content.

10. The control method as claimed in claim 9, wherein the step (b) includes:
a first comparing substep configured to compare the previously-arranged and the subsequently-arranged scheduled recordings with respect to the first categorical attribute;
a second comparing substep configured to compare the previously-arranged and the subsequently-arranged scheduled recordings with respect to the second categorical attribute; and
a determining substep configured to determine selection of one of the previously-arranged and the subsequently-arranged scheduled recordings, the selection being determined according to a priority order between the previously-arranged and the subsequently-arranged scheduled recordings in a case where the priority order is obtained based on a result of the comparison by the first comparison substep, and the selection being determined based on a result of the comparison by the second comparison substep in a case where the priority order is not obtained based on the result of the comparison by the first comparison substep.

11. A computer-readable recording medium having a program stored thereon, the program being for causing a computer to execute a control method of a recording apparatus having a function of arranging one or more scheduled recordings of content, the program including instructions to cause the computer to execute the steps of:
(a) setting an attribute of content when each scheduled recording is arranged; and
(b) in a case when a previously-arranged scheduled recording and a subsequently-arranged scheduled recording conflict with each other, resolving the conflict according to priorities assigned to attributes of content of the previously-arranged and the subsequently-arranged scheduled recordings.

12. The computer-readable recording medium as claimed in claim 11, wherein the program further includes an instruction to cause the computer to execute a step of informing, in a case of cancelling the previously-arranged scheduled recording and selecting the subsequently-arranged scheduled recording in accordance with the priorities so as to resolve the conflict, a user that requested the previously-arranged scheduled recording about the cancellation and information related to the cancellation.

13. The computer-readable recording medium as claimed in claim 12, wherein the information related to the cancellation includes at least one of a user name and a content name pertaining to the subsequently-arranged scheduled recording.

14. The computer-readable recording medium as claimed in claim 11, wherein the attribute of the content of each scheduled recording includes a first categorical attribute related to a providing style of the content and a second categorical attribute related to a characteristic of the content.

15. The computer-readable recording medium as claimed in claim 14, wherein the step (b) includes:
a first comparing substep configured to compare the previously-arranged and the subsequently-arranged scheduled recordings with respect to the first categorical attribute;
a second comparing substep configured to compare the previously-arranged and the subsequently-arranged scheduled recordings with respect to the second categorical attribute; and
a determining substep configured to determine selection of one of the previously-arranged and the subsequently-arranged scheduled recordings, the selection being determined according to a priority order between the previously-arranged and the subsequently-arranged scheduled recordings in a case where the priority order is obtained based on a result of the comparison by the first comparison substep, and the selection being determined based on a result of the comparison by the second comparison substep in a case where the priority order is not obtained based on the result of the comparison by the first comparison substep.
